(19) United States
(12) Patent Application Publication
(10) Pub. No.: US 2026/0117456 A1
(43) Pub. Date: Apr. 30, 2026

(54) LCE-BASED ARTIFICIAL MUSCLE FIBER AND PREPARATION METHOD AND USE THEREOF

(71) Applicant: NANJING DRUM TOWER HOSPITAL, Nanjing (CN)

(72) Inventors: Yulian WANG, Nanjing (CN); Pingqiang CAI, Nanjing (CN); Qing JIANG, Nanjing (CN); Xiao PAN, Nanjing (CN)

(73) Assignee: NANJING DRUM TOWER HOSPITAL, Nanjing (CN)

(21) Appl. No.: 19/240,002

(22) Filed: Jun. 17, 2025

Related U.S. Application Data
(63) Continuation of application No. PCT/CN2024/131173, filed on Nov. 11, 2024.

(30) Foreign Application Priority Data
Oct. 30, 2024 (CN) 202411532410.0

(51) Int. Cl. D06M 15/263; D06M 15/71; D06M 101/34; D06M 101/40; F03G 7/06

(52) U.S. Cl. CPC D06M 15/263; D06M 15/71; D06M 2101/34; D06M 2101/40; F03G 7/06143

(57) ABSTRACT

An electroheat-driven LCE-based artificial muscle fiber is provided, and the overall mechanical strength of the electroheat-driven LCE-based artificial muscle fiber is improved under the condition that the driving performance of the fiber is not affected, quick and accurate driving may be realized, and the electroheat-driven LCE-based artificial muscle fiber has the characteristic of a quick response. An electroheat-driven LCE artificial muscle has a high sensitivity, driving capacity and output, may reach the maximum driving capacity of 60% within 0.3 s, and has a large driving force under the condition of guaranteeing a high driving capacity, thereby having a broad research prospect in the fields of flexible electronics, soft robots and rehabilitation. A preparation method has a simple preparation process, is easy to operate, and may realize mass preparation.

### CROSS REFERENCE TO THE RELATED APPLICATIONS

This application is a continuation application of International Application No. PCT/CN2024/131173, filed on Nov. 11, 2024, which is based upon and claims priority to Chinese Patent Application No. 202411532410.0, filed on Oct. 30, 2024, the entire contents of which are incorporated herein by reference.

### TECHNICAL FIELD

The invention belongs to the technical field of artificial muscles, and particularly relates to a liquid crystal elastomer (LCE)-based artificial muscle fiber and a preparation method and uses thereof.

### BACKGROUND

In the technical fields of material science and smart robots, the rapid development of flexible electronics technology promotes the emergence of a series of innovative materials, which have unprecedented properties and further drive the development of soft robots. With the deepening of research, novel composite fiber materials emerge and show remarkable characteristics in man-machine interaction, deformation recovery and mechanical properties. Such composite fiber materials are widely considered as key drive units in soft robots (i.e., artificial muscle fibers). They not only may provide large power outputs, but also may operate in low-noise environments, endowing robots with an unprecedented degree of freedom and flexibility. In addition, artificial muscle fibers may be combined with the flexible electronics technology to realize self-perception and feedback, which is of great importance for the construction of autonomous and dexterous soft robots.

Artificial muscle fibers have extremely high performance requirements, including quick drive response, large drive strain and stress, and good flexibility and controllability. All these requirements promote the research and development of LCE fibers. The LCE fibers are formed by orientated liquid crystal polymers and have a good thermal pinch effect in the molecular chain direction, thus having good deformability, mechanical properties and reversible deformability and becoming ideal materials for manufacturing artificial muscles. Although the LCE fibers show a great potential in manufacturing artificial muscles, drive mechanisms proposed in existing research generally depend on external factors such as environmental heating, light, magnetism or humidity, which limit the controllability of robot systems. The electroheat technology has an application potential particularly in artificial muscle fibers. Electroheat-driven artificial muscle fibers may realize quick response and accurate control, which is of great importance for improving the performance of robots.

Electroheat-driven LCE artificial muscles have the advantages of quick response, high power output and good controllability. Such a driving method may directly convert electric energy into heat energy and realize quick contraction and relaxation of artificial muscles by means of thermal expansion or phase changes of materials. Compared with light heating, magnetic heating, direct heating and other traditional methods, electroheat driving avoids the dependency on external light sources or magnetic fields and provides more stable and controllable power output. The electroheat-driven LCE artificial muscles also have the features of being simple in structure and easy to integrate. By controlling the magnitude and direction of the current, the degree of contraction and motion pattern of muscles may be accurately controlled to realize good controllability and flexibility. In addition, the high response speed of electroheat driving allows for deformation of materials in milliseconds, which is of particular importance for application scenarios requiring a quick response. In addition, the electroheat-driven LCE artificial muscles have good environmental adaptability and are able to operate stably in different environmental conditions, including extreme temperature and humidity conditions, which improve the application probability of artificial muscles.

As for electroheat driving methods for LCEs, researchers have developed various strategies to fulfill efficient and controllable driving performance. For example, liquid metal (such as mercury and gallium) is combined with LCEs, and the LCEs are driven to deform by means of the electroheat effect of the liquid metal. Such a method has the advantages such that the fluidity of the liquid metal will not restrain the deformation of the LCEs, but the mechanical strength of the LCEs may be reduced by the liquid metal. Another common electroheat driving method is to inlaid S-shaped metal wires in LCEs, and when a current passes through the metal wires, the metal wires will generate heat to lead to deformation of the LCEs. However, the addition of the metal wires may compromise the uniformity of the LCEs, thus reducing the overall driving performance of the LCEs. Compounding of LCEs and nanocarbon materials: nanocarbon materials such as graphene and carbon nano tubes are used for electroheat driving of LCEs because of their good electrical conductivity and thermal performance. By compounding these materials, the electro-thermal conversion efficiency may be improved. But, the electrical conductivity of these materials is inferior to that of metal, which may compromise the driving performance.

### SUMMARY

Objective of the invention: An object of the invention is to provide an electroheat-driven LCE-based artificial muscle fiber, and the overall mechanical strength of the electroheat-driven LCE-based artificial muscle fiber is improved under the condition that the driving performance of the fiber is not affected, quick and accurate driving may be realized.

Technical solution: The LCE-based artificial muscle fiber according to the invention is prepared from a spring-shaped conductive fiber and an LCE oligomer.

Preferably, the conductive fiber is one of a metal wire, a nylon fiber, a carbon fiber, a conductive polymer, a shape memory alloy wire and a carbon nano tube wire.

The invention further provides a preparation method of the LCE-based artificial muscle fiber, including the following steps:
(1) preparing a spring-shaped conductive fiber;
(2) preparing an LCE oligomer; and
(3) preparing the LCE-based artificial muscle fiber: injecting an LCE oligomer solution obtained in Step (2) into a tetrafluoroethylene tube containing the conductive fiber prepared in Step (1); stripping the tetrafluoroethylene tube after a cross-linking reaction to obtain an LCE fiber in a multi-domain state, removing a solvent, and then stretching the LCE fiber in the multi-domain state and performing cross-linking again to obtain the final LCE-based artificial muscle fiber.

Preferably, the tetrafluoroethylene tube has an inner diameter of 1-6 mm.

Preferably, in the step of stretching the LCE fiber in the multi-domain state, the LCE fiber in the multi-domain state is mechanically stretched three times by means of a mechanical stretching method.

Preferably, a preparation method of the spring-shaped conductive fiber includes: winding a conductive fiber on a stainless steel spindle, and after high-temperature heating and annealing, extracting the spindle to obtain the densely-wound spring-shaped conductive fiber.

Preferably, the conductive fiber has a diameter of 0.1-1.0 mm, the stainless steel spindle has a diameter of 0.6-3.0 mm, and the high-temperature heating and annealing are performed at 120-180° C. for 1.5-3 h.

Preferably, the LCE oligomer is prepared by an Aza-Michael reaction method specifically as follows: dissolving a liquid crystal monomer, a chain extender, a cross-linking agent and a photoinitiator in a solvent, stirring at a temperature of 40-80° C. to prepare a solution, adding a catalyst, and stirring again to obtain the LCE oligomer solution.

Preferably, the liquid crystal monomer is any one or two selected from 1,4-bis-[4-(3-acryloyloxypropyloxy)benzoyloxy]-2-methylbenze) or 2-methyl-1,4-phenylene bis(4-((6-(acryloylonxy)hexyl)oxy)benzoate); and the chain extender is any one or more selected from 3,6-dioxa-1,8-octanedithiol, ethylene glycol bis(3-mercaptopropionate), 1,4-butanediol bis(thioglycolate), ethylene glycol bis(mercaptoacetate), Bis(2-mercaptoethyl) ether, 1,3-dimercaptopropane, 1,6-hexanedithiol and 1,10-decanedithiol.

Preferably, the solvent is any one or more selected from dichloromethane, ethyl acetate, methylbenzene and acetone; and the cross-linking agent is pentaerythritol tetrakis (3-mercapto-propionate), the photoinitiator is 2,2-dimethoxy-1,2-diphenylethanone, and the catalyst is di-n-propylamine.

The invention further provides a use of the LCE-based artificial muscle fiber for preparation of flexible electronics and soft robots.

### Beneficial Effect

According to an electroheat-driven LCE-based artificial muscle fiber provided by the invention, first, a conductive spring is constructed, and then an LCE is wrapped by means of a template method, wherein the conductive spring functions as a support framework, improves the dynamic output, and will not hinder the deformation effect of the LCE when the LCE deforms; and the overall mechanical strength of the electroheat-driven LCE-based artificial muscle fiber is improved under the condition that the driving performance of the fiber is not affected, quick and accurate driving may be realized, and the electroheat-driven LCE-based artificial muscle fiber has the characteristic of a quick response. An electroheat-driven LCE artificial muscle has a high sensitivity, driving capacity and output, may reach the maximum driving capacity of 60% within 0.3 s, and has a large driving force under the condition of guaranteeing a high driving capacity, thereby having a broad research prospect in the fields of flexible electronics, soft robots and rehabilitation. A preparation method provided by the invention has a simple preparation process, is easy to operate, and may realize mass preparation.

### BRIEF DESCRIPTION OF THE DRAWINGS

FIGS. 1A-IC show a preparation flow diagram of a spring-shaped conductive fiber according to the invention.

FIGS. 2A-2F show a preparation flow diagram of an artificial muscle fiber according to the invention.

FIG. 3 is an optical photograph of the artificial muscle fiber according to the invention.

FIG. 4 illustrates the driving capacity of the artificial muscle fiber at a frequency of 0.1 Hz (duty cycle 5%) under different voltages according to the invention.

FIG. 5 illustrates the driving capacity of the artificial muscle fiber at a frequency of 0.1 Hz (duty cycle 10%) under different voltages according to the invention.

FIG. 6 illustrates the comparison of driving performance characterizations of conductive LCE fibers prepared from nylon fibers with different diameters.

### DETAILED DESCRIPTION OF THE EMBODIMENTS

In order to deepen the understanding of the invention, the invention will be further described in detail below in conjunction with embodiments and drawings. The embodiments are only used to explain the invention and do not constitute a limitation on the scope of the invention.

### Embodiment 1

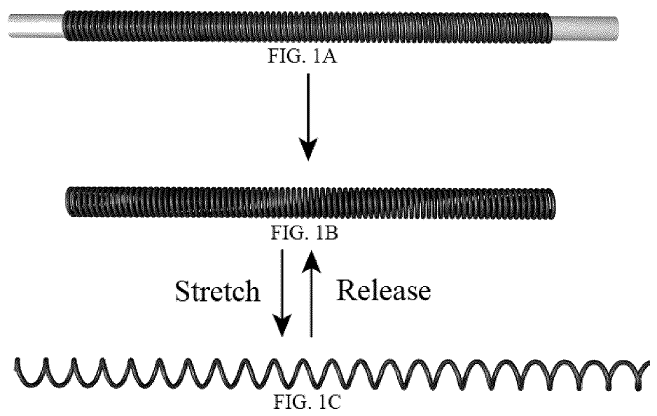

(1) Preparation of a conductive spring: a conductive nylon fiber with a diameter of 0.1 mm was used as a conductive fiber and uniformly wound around a stainless steel spindle with a diameter of 0.6 mm (FIG. 1A), the conductive nylon fiber was annealed in an oven at a temperature of 120° C. for 3 h after two ends of the conductive nylon fiber were fixed, and the spindle was extracted out to obtain a densely-wound conductive nylon spring (FIG. 1B), wherein the conductive spring had good elasticity and might be stretched by over 500% (FIG. 1C).

(2) Preparation of an LCE oligomer: the LCE oligomer was prepared by an Aza-Michael reaction method specifically follows: a 2.0 mmol of a liquid crystal monomer (RM257, 1,4-bis-[4-(3-acryloyloxypropyloxy)benzoyloxy]-2-methylbenze), 1.73 mmol of a chain extender (EDDET, 3,6-dioxa-1,8-octanedithiol), 0.173 mmol of a cross-linking agent (PETMP, pentaerythritol tetrakis (3-mercapto-propionate)) and 0.04 mmol of a photoinitiator (IG-651, 2,2-dimethoxy-1,2-diphenylethanone) were dissolved in 1.2 mL of dichloromethane and stirred at a temperature of 50° C. for 20 min to prepare a solution; and finally, 0.04 mmol of a catalyst (DPA, di-n-propylamine) was added and further stirred for 1 min to obtain an LCE oligomer solution (transparent liquid) for later use.

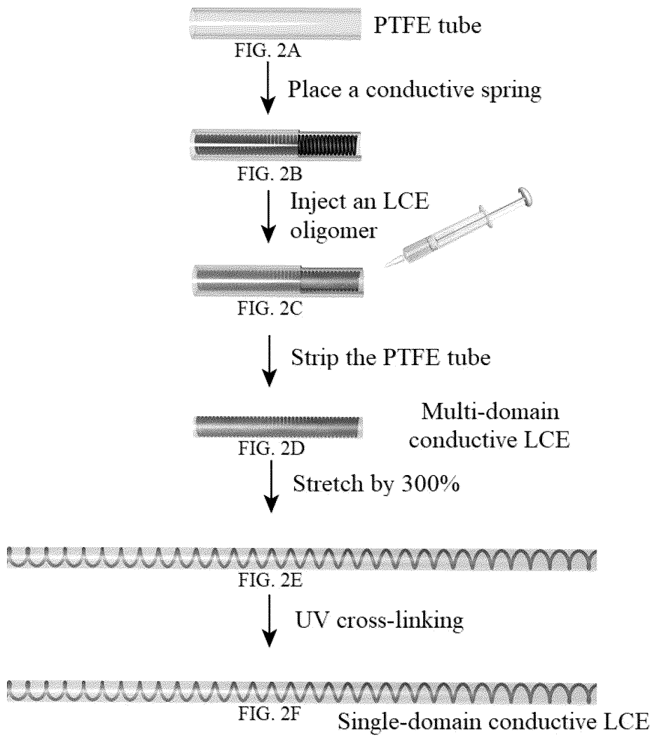

(3) Preparation of a conductive LCE fiber: the conductive nylon spring prepared in Step (1) was placed in a tetrafluoroethylene tube with an inner diameter of 1.0 mm (FIGS. 2A-2B), and the LCE oligomer solution obtained in Step (2) was injected into the tetrafluoroethylene tube containing the conductive nylon spring by means of an injector (FIG. 2C); the tetrafluoroethylene tube was preliminarily cross-linked for 24 h in a dark condition, and then the tetrafluoroethylene tube was stripped to obtain a conductive LCE fiber in a multi-domain state (FIG. 2D), the conductive LCE fiber in the multi-domain state was placed in an oven at a temperature of 80° C. to separate an excess solvent for 24 h (FIG. 2E); and the conductive LCE fiber in the multi-domain state was mechanically stretched three times by means of a mechanical stretching method and cross-linked under ultraviolet light for a second time for 15 min to obtain a uniaxial oriented conductive LCE fiber, that is, a final conductive LCE fiber was obtained for later use (FIG. 2F).

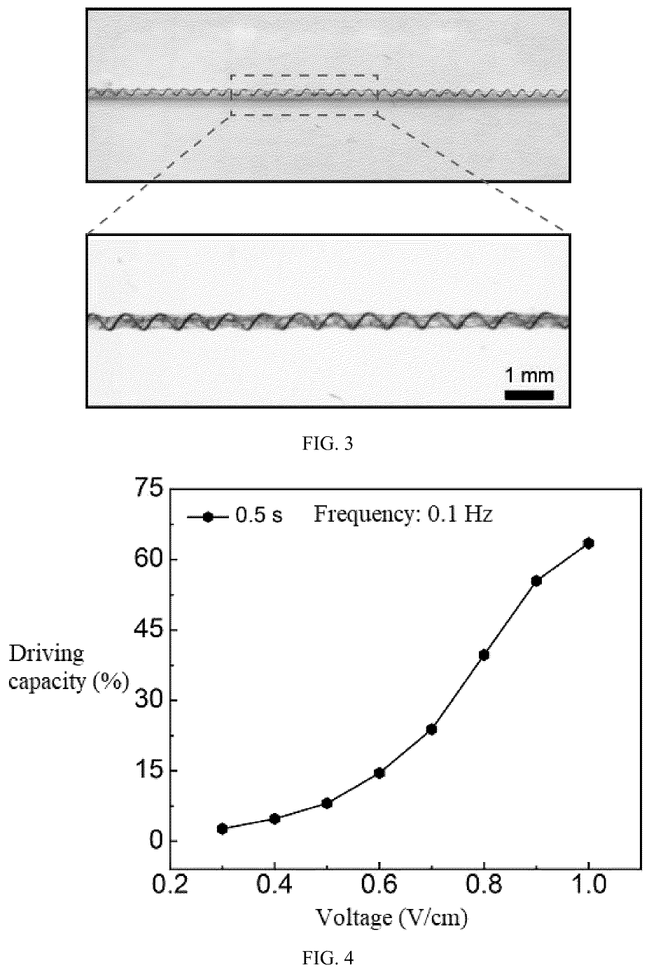

As shown in FIG. 3 which is an optical photograph of the conductive LCE fiber in this embodiment, the diameter of the fiber was 0.7 mm. When the conductive LCE fiber was mechanically stretched, mesogenic units were converted from a nematic phase to an isotropic phase, such that a microscopic deformation is caused, thereby fulfilling good driving performance. WAXS was used for characterizing the orientation in the conductive LCE fiber.

### Embodiment 2

(1) Preparation of a conductive spring: a carbon fiber with a diameter of 0.1 mm was used as a conductive fiber, the conductive fiber was twisted to a certain twist (not to a spiral state) and uniformly wound around a stainless steel spindle with a diameter of 1.0 mm, the carbon fiber was annealed in an oven at a temperature of 150° C. for 2 h after two ends of the conductive fiber were fixed, and the spindle was extracted out to obtain a densely-wound conductive carbon fiber spring.

(2) This step is the same as Step (2) in Embodiment 1.

(3) Preparation of a conductive LCE fiber: (1) the conductive carbon fiber spring prepared in Step (1) was placed in a tetrafluoroethylene tube with an inner diameter of 1.0 mm, and the LCE oligomer solution prepared in Step (2) was injected into the tetrafluoroethylene tube containing the conductive carbon fiber spring by means of an injector; the tetrafluoroethylene tube was preliminarily cross-linked for 24 h in a dark condition, then the tetrafluoroethylene tube was stripped to obtain a conductive LCE fiber in a multi-domain state, and the conductive LCE fiber in the multi-domain state was placed in an oven at a temperature of 60° C. to separate any excess solvents for 24 h; and the conductive LCE fiber in the multi-domain state was mechanically stretched three times by means of a mechanical stretching method and cross-linked under ultraviolet light for a second time for 15 min to obtain a final conductive LCE fiber for later use.

### Embodiment 3

(1) Preparation of a conductive spring: a conductive nylon fiber with a diameter of 0.1 mm was used as a conductive fiber and uniformly wound around a stainless steel spindle with a diameter of 0.6 mm (FIG. 1A), the conductive nylon fiber was annealed in an oven at a temperature of 140° C. for 2.5 h after two ends of the conductive nylon fiber were fixed, and the spindle was extracted out to obtain a densely-wound conductive nylon spring (FIG. 1B), wherein the conductive spring had good elasticity and might be stretched by over 500% (FIG. 1C).

(2) Preparation of an LCE oligomer: the LCE oligomer was prepared by an Aza-Michael reaction method specifically follows: a 2.0 mmol of a liquid crystal monomer (RM257, 1,4-bis-[4-(3-acryloyloxypropyloxy)benzoyloxy]-2-methylbenze), 1.73 mmol of a chain extender (DDT, 1,10-Decanedithio), 0.173 mmol of a cross-linking agent (PETMP, pentaerythritol tetrakis (3-mercapto-propionate)) and 0.04 mmol of a photoinitiator (IG-651, 2,2-dimethoxy-1,2-diphenylethanone) were dissolved in 1.2 mL of ethyl acetate and stirred at a temperature of 50° C. for 20 min to prepare a solution; and finally, 0.04 mmol of a catalyst (DPA, di-n-propylamine) was added and further stirred for 1 min to obtain an LCE oligomer solution (transparent liquid) for later use.

(3) This step is the same as Step (3) in Embodiment 1.

### Embodiment 4

(1) This step is the same as Step (1) in Embodiment 1.

(2) Preparation of an LCE oligomer: the LCE oligomer was prepared by an Aza-Michael reaction method specifically follows: a 2.0 mmol of a liquid crystal monomer (RM257, 1,4-bis-[4-(3-acryloyloxypropyloxy)benzoyloxy]-2-methylbenze), 1.73 mmol of a chain extender (HDT, 1,6-Hexanedithiol), 0.173 mmol of a cross-linking agent (PETMP, pentaerythritol tetrakis (3-mercapto-propionate)) and 0.04 mmol of a photoinitiator (IG-651, 2,2-dimethoxy-1,2-diphenylethanone) were dissolved in 1.2 mL of methylbenzene and stirred at a temperature of 50° C. for 20 min to prepare a solution; and finally, 0.04 mmol of a catalyst (DPA, di-n-propylamine) was added and further stirred for 1 min to obtain an LCE oligomer solution (transparent liquid) for later use.

(3) This step is the same as Step (3) in Embodiment 1.

### Embodiment 5

The driving performance of the conductive LCE fiber prepared in Embodiment 1 was tested at the frequency of 0.1 Hz (duty cycle 5%) under different voltages, as shown in FIG. 4. Under the voltage of 1.0 V/cm, the maximum driving capacity under the voltage of 1.0 V/cm may reach 65%, and with the increase of the voltage, the driving capacity tends to increase, indicating that the conductive LCE fiber has a high driving capacity.

### Embodiment 6

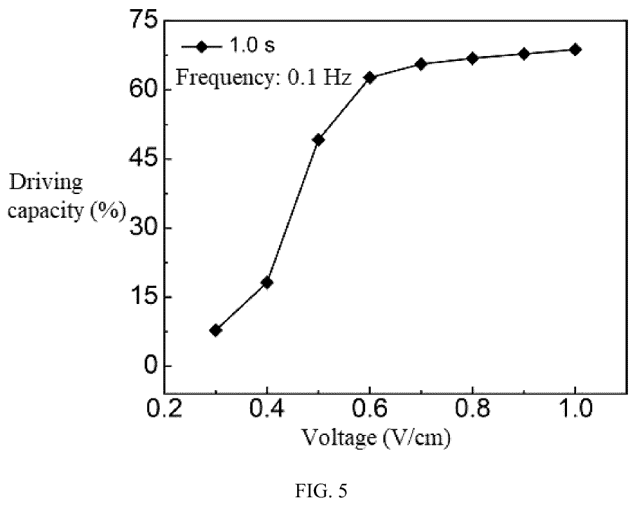

The driving performance of the conductive LCE fiber prepared in Embodiment 1 was tested at the frequency of 0.1 Hz (duty cycle 10%) under different voltages, as shown in FIG. 5. Under the voltage of 1.0 V/cm, the maximum driving capacity under the voltage of 1.0 V/cm may reach 70%, and with the increase of the voltage, the driving capacity tends to increase, indicating that the conductive LCE fiber has a high driving capacity. Compared with Embodiment 2, the duty cycle was increased, the power-on time was prolonged, and the driving capacity was improved.

### Embodiment 7

(1) Preparation of a conductive spring: a conductive nylon fiber with a diameter of 0.2 mm was used as a conductive fiber and uniformly wound around a stainless steel spindle with a diameter of 0.6 mm, the conductive nylon fiber was annealed in an oven at a temperature of 120° C. for 3 h after two ends of the conductive nylon fiber were fixed, and the spindle was extracted to obtain a densely-wound conductive nylon spring.

(2) This step is the same as Step (2) in Embodiment 1.

(3) Preparation of a conductive LCE fiber: the conductive nylon spring prepared in Step (1) was placed in a tetrafluoroethylene tube with an inner diameter of 1.2 mm, and the other steps are the same as those in Step (3) in Embodiment 1.

### Embodiment 8

(1) Preparation of a conductive spring: a conductive nylon fiber with a diameter of 0.3 mm was used as a conductive fiber and uniformly wound around a stainless steel spindle with a diameter of 0.6 mm, the conductive nylon fiber was annealed in an oven at 120° C. for 3 h after two ends of the conductive nylon fiber were fixed, and the spindle was extracted to obtain a densely-wound conductive nylon spring.

(2) This step is the same as Step (2) in Embodiment 1.

(3) Preparation of a conductive LCE fiber: the conductive nylon spring prepared in Step (1) was placed in a tetrafluoroethylene tube with an inner diameter of 1.4 mm, and the other steps are the same as those in Step (3) in Embodiment 1.

### Embodiment 9

(1) Preparation of a conductive spring: a conductive nylon fiber with a diameter of 0.4 mm was used as a conductive fiber and uniformly wound around a stainless steel spindle with a diameter of 0.6 mm, the conductive nylon fiber was annealed in an oven at 150° C. for 2 h after two ends of the conductive nylon fiber were fixed, and the spindle was extracted to obtain a densely-wound conductive nylon spring.

(2) This step is the same as Step (2) in Embodiment 1.

(3) Preparation of a conductive LCE fiber: the conductive nylon spring prepared in Step (1) was placed in a tetrafluoroethylene tube with an inner diameter of 1.6 mm, and the other steps are the same as those in Step (3) in Embodiment 1.

### Embodiment 10

(1) Preparation of a conductive spring: a conductive nylon fiber with a diameter of 0.5 mm was used as a conductive fiber and uniformly wound around a stainless steel spindle with a diameter of 0.6 mm, the conductive nylon fiber was annealed in an oven at 120° C. for 3 h after two ends of the conductive nylon fiber were fixed, and the spindle was extracted to obtain a densely-wound conductive nylon spring.

(2) This step is the same as Step (2) in Embodiment 1.

(3) Preparation of a conductive LCE fiber: the conductive nylon spring prepared in Step (1) was placed in a tetrafluoroethylene tube with an inner diameter of 1.8 mm, and the other steps are the same as those in Step (3) in Embodiment 1.

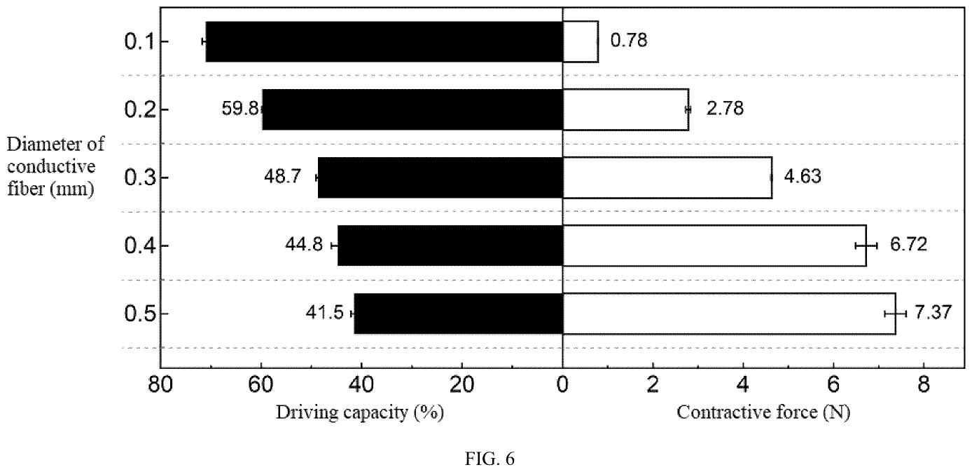

The driving performance characterizations (driving capacity and contractive force) of the conductive LCE fibers prepared from nylon fibers with different parameters are compared, as shown in FIG. 6. It may be seen from FIG. 6 that the driving force of the conductive LCE fibers is greatly improved under the condition that the maximum driving capacity (>30%) is guaranteed.

The embodiments described above are merely preferred embodiments of the invention and not intended to limit the invention. Any of modifications, equivalent substitutions, improvements, etc. made within the spirit and principle of the invention shall be covered in the scope of the invention.

What is claimed is:

1. A liquid crystal elastomer (LCE)-based artificial muscle fiber, wherein the LCE-based artificial muscle fiber is prepared from a spring-shaped conductive fiber and an LCE oligomer, wherein a conductive fiber is one of a metal wire, a nylon fiber, a carbon fiber, a conductive polymer, a shape memory alloy wire, and a carbon nano tube wire.

2. A preparation method of the LCE-based artificial muscle fiber according to claim 1, comprising the following steps:
1) preparing the spring-shaped conductive fiber;
2) preparing the LCE oligomer; and
3) preparing the LCE-based artificial muscle fiber: injecting a solution of the LCE oligomer obtained in the step 2) into a tetrafluoroethylene tube containing the spring-shaped conductive fiber prepared in the step 1); stripping the tetrafluoroethylene tube after a cross-linking reaction to obtain an LCE fiber in a multi-domain state, removing a first solvent, and then stretching the LCE fiber in the multi-domain state and performing the cross-linking reaction again to obtain the LCE-based artificial muscle fiber.

3. The preparation method according to claim 2, wherein the tetrafluoroethylene tube has an inner diameter of 1-6 mm.

4. The preparation method according to claim 2, wherein in the step of stretching the LCE fiber in the multi-domain state, the LCE fiber in the multi-domain state is mechanically stretched three times by a mechanical stretching method.

5. The preparation method according to claim 2, wherein a preparation method of the spring-shaped conductive fiber comprises: winding the conductive fiber on a stainless steel spindle, and after a high-temperature heating and an annealing, extracting the stainless steel spindle to obtain the spring-shaped conductive fiber.

6. The preparation method according to claim 5, wherein the conductive fiber has a diameter of 0.1-1.0 mm, the stainless steel spindle has a diameter of 0.6-3.0 mm, and the high-temperature heating and the annealing are performed at 120-180° C. for 1.5-3 h.

7. The preparation method according to claim 2, wherein the LCE oligomer is prepared by an Aza-Michael reaction method as follows: dissolving a liquid crystal monomer, a chain extender, a cross-linking agent, and a photoinitiator in a second solvent, stirring at a temperature of 40-80° C. to prepare a solution, adding a catalyst, and stirring again to obtain the solution of the LCE oligomer.

8. The preparation method according to claim 7, wherein the liquid crystal monomer is one or two selected from 1,4-bis-[4-(3-acryloyloxypropyloxy)benzoyloxy]-2-methylbenze) or 2-methyl-1,4-phenylene bis(4-((6-(acryloylonxy)hexyl)oxy)benzoate); and the chain extender is one or more selected from 3,6-dioxa-1,8-octanedithiol, ethylene glycol bis(3-mercaptopropionate), 1,4-butanediol bis(thioglycolate), ethylene glycol bis(mercaptoacetate), Bis(2-mercaptoethyl) ether, 1,3-dimercaptopropane, 1,6-hexanedithiol, and 1,10-decanedithiol.

9. The preparation method according to claim 7, wherein the second solvent is one or more selected from dichloromethane, ethyl acetate, methylbenzene, and acetone; and the cross-linking agent is pentaerythritol tetrakis (3-mercapto-propionate), the photoinitiator is 2,2-dimethoxy-1,2-diphenylethanone, and the catalyst is di-n-propylamine.

10. A method for preparing flexible electronics and soft robots, comprising using the LCE-based artificial muscle fiber according to claim 1.

11. The method according to claim 10, wherein a preparation method of the LCE-based artificial muscle fiber comprises the following steps:
1) preparing the spring-shaped conductive fiber;
2) preparing the LCE oligomer; and
3) preparing the LCE-based artificial muscle fiber: injecting a solution of the LCE oligomer obtained in the step 2) into a tetrafluoroethylene tube containing the spring-shaped conductive fiber prepared in the step 1); stripping the tetrafluoroethylene tube after a cross-linking reaction to obtain an LCE fiber in a multi-domain state, removing a first solvent, and then stretching the LCE fiber in the multi-domain state and performing the cross-linking reaction again to obtain the LCE-based artificial muscle fiber.

12. The method according to claim 11, wherein in the preparation method, the tetrafluoroethylene tube has an inner diameter of 1-6 mm.

13. The method according to claim 11, wherein in the preparation method, the LCE fiber in the multi-domain state is mechanically stretched three times by a mechanical stretching method in the step of stretching the LCE fiber in the multi-domain state.

14. The method according to claim 11, wherein in the preparation method, a preparation method of the spring-shaped conductive fiber comprises: winding the conductive fiber on a stainless steel spindle, and after a high-temperature heating and an annealing, extracting the stainless steel spindle to obtain the spring-shaped conductive fiber.

15. The method according to claim 14, wherein in the preparation method, the conductive fiber has a diameter of 0.1-1.0 mm, the stainless steel spindle has a diameter of 0.6-3.0 mm, and the high-temperature heating and the annealing are performed at 120-180° C. for 1.5-3 h.

16. The method according to claim 11, wherein in the preparation method, the LCE oligomer is prepared by an Aza-Michael reaction method as follows: dissolving a liquid crystal monomer, a chain extender, a cross-linking agent, and a photoinitiator in a second solvent, stirring at a temperature of 40-80° C. to prepare a solution, adding a catalyst, and stirring again to obtain the solution of the LCE oligomer.

17. The method according to claim 16, wherein in the preparation method, the liquid crystal monomer is one or two selected from 1,4-bis-[4-(3-acryloyloxypropyloxy)benzoyloxy]-2-methylbenze) or 2-methyl-1,4-phenylene bis(4-((6-(acryloylonxy)hexyl)oxy)benzoate); and the chain extender is one or more selected from 3,6-dioxa-1,8-octanedithiol, ethylene glycol bis(3-mercaptopropionate), 1,4-butanediol bis(thioglycolate), ethylene glycol bis(mercaptoacetate), Bis(2-mercaptoethyl) ether, 1,3-dimercaptopropane, 1,6-hexanedithiol, and 1,10-decanedithiol.

18. The method according to claim 16, wherein in the preparation method, the second solvent is one or more selected from dichloromethane, ethyl acetate, methylbenzene, and acetone; and the cross-linking agent is pentaerythritol tetrakis (3-mercapto-propionate), the photoinitiator is 2,2-dimethoxy-1,2-diphenylethanone, and the catalyst is di-n-propylamine.
